(19) United States
(12) Patent Application Publication
(10) Pub. No.: US 2023/0370807 A1
(43) Pub. Date: Nov. 16, 2023

(54) SENSOR INTEGRATION AND AGGREGATION FOR AUGMENTED AWARENESS

(71) Applicant: AT&T Intellectual Property I, L.P., Atlanta, GA (US)

(72) Inventors: Eric Zavesky, Austin, TX (US); Louis Alexander, Franklin, NJ (US); Jean-Francois Paiement, Palm Desert, CA (US); Wen-Ling Hsu, Bridgewater, NJ (US); David Gibbon, Lincroft, NJ (US); Jianxiong Dong, Pleasanton, CA (US)

(21) Appl. No.: 17/663,150

(22) Filed: May 12, 2022

(51) Int. Cl. H04W 4/021; H04L 67/55

(52) U.S. Cl. CPC H04W 4/021; H04L 67/55

(57) ABSTRACT

In one example, a method performed by a processing system including at least one processor includes downloading at least one digital resource relating to a user-defined location, acquiring data about the user-defined location from a sensor located in the user-defined location, while the user is present in the user-defined location, detecting a user need based on the data from the sensor, augmenting the at least one digital resource with the data from the sensor to produce content that is responsive to the user need, and presenting the content that is responsive to the user need.

The present disclosure relates generally to network connected devices, and relates more particularly to devices, non-transitory computer-readable media, and methods for integrating and aggregating data from a plurality of distributed sensors in order to enhance human awareness of conditions and surroundings.

### BACKGROUND

Wireless communications, including mobile broadband communications, WiFi communications, satellite communications, and others, allow users to send and receive information almost instantly, from any location. For instance, wireless communications allow users to make phone calls, send text and multimedia messages, control remote devices, access the Internet and network-enabled applications, and the like.

### SUMMARY

In one example, the present disclosure describes a device, computer-readable medium, and method for enhancing human awareness of conditions and surroundings by integrating and aggregating data from a plurality of distributed sensors. For instance, in one example, a method performed by a processing system including at least one processor includes downloading at least one digital resource relating to a user-defined location, acquiring data about the user-defined location from a sensor located in the user-defined location, while the user is present in the user-defined location, detecting a user need based on the data from the sensor, augmenting the at least one digital resource with the data from the sensor to produce content that is responsive to the user need, and presenting the content that is responsive to the user need.

In another example, a non-transitory computer-readable medium stores instructions which, when executed by a processing system, including at least one processor, cause the processing system to perform operations. The operations include downloading at least one digital resource relating to a user-defined location, acquiring data about the user-defined location from a sensor located in the user-defined location, while the user is present in the user-defined location, detecting a user need based on the data from the sensor, augmenting the at least one digital resource with the data from the sensor to produce content that is responsive to the user need, and presenting the content that is responsive to the user need.

In another example, a device includes a processing system including at least one processor and a computer-readable medium storing instructions which, when executed by the processing system, cause the processing system to perform operations. The operations include downloading at least one digital resource relating to a user-defined location, acquiring data about the user-defined location from a sensor located in the user-defined location, while the user is present in the user-defined location, detecting a user need based on the data from the sensor, augmenting the at least one digital resource with the data from the sensor to produce content that is responsive to the user need, and presenting the content that is responsive to the user need.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure may operate;

FIG. 2 illustrates a flowchart of an example method for integrating and aggregating data from a plurality of distributed sensors to enhance human awareness of surroundings and conditions in accordance with the present disclosure; and

FIG. 3 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure enhances human awareness of conditions and surroundings by integrating and aggregating data from a plurality of distributed sensors. As discussed above, wireless communications, including mobile broadband communications, WiFi communications, satellite communications, and others, allow users to send and receive information almost instantly, from any location. For instance, wireless communications allow users to make phone calls, send text and multimedia messages, control remote devices, access digital resources (e.g., topographical maps, weather reports, etc.) and applications (e.g., global positioning system applications, social media applications, etc.), and the like.

However, the availability and reliability of the infrastructure needed to support mobile communications may vary widely from one location to another. For instance, the infrastructure in a densely inhabited location such as a large city may provide relatively reliable support for mobile communications, while the infrastructure in a less densely inhabited location such as a remote forested area may provide relatively poor support. Moreover, even those digital resources that can be accessed may be limited to macro-level areas and may not specifically pertain to a location in which a user is currently present (e.g., a weather report may relate generally to an entire town, rather than specifically to a small part of the town that borders the ocean).

As a result, users venturing into unfamiliar locations may find themselves stranded without access to critical information or services. For instance, a user who is hiking in a remote area may have trouble accessing trail maps to determine the route they need to take or contacting emergency personnel in the event of an emergency (e.g., injury, natural disaster, running out of drinking water, etc.). Furthermore, emergency personnel responding to incidents in remote locations may encounter difficulties in providing timely assistance to individuals in distress. For instance, firefighters may be unable to gauge the full extent and layout of a forest fire, or medical personnel may have trouble locating an injured individual or accessing the area where an injured individual is determined to be.

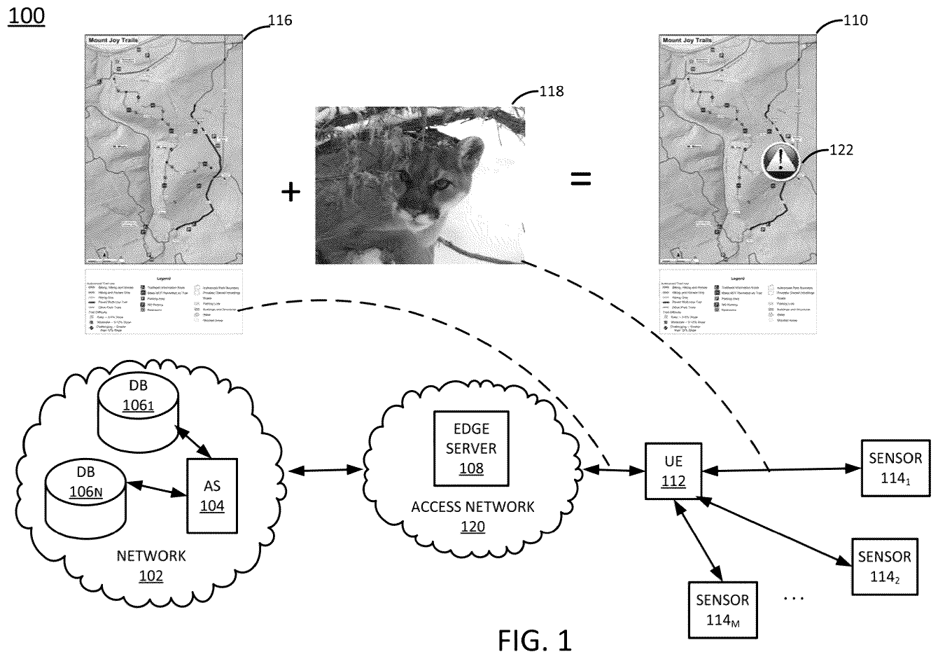

Examples of the present disclosure provide a system that enhances human awareness of conditions and surroundings by aggregating static or semi-static digital resources (which may be downloaded in advance of venturing into an unfamiliar area) with dynamic sensor data (which may be collected in real time from sensors located throughout the area). For instance, the static or semi-static digital resources might include maps, weather forecasts, and other data that can be downloaded via a connection to the Internet, while the sensor may include images, thermometer readings, motion sensor readings, and the like that may be downloaded directly from the sensors using proximity-based wireless communication techniques (e.g., near field communication). Aggregating the digital resources with the sensor data may allow a user's location to be tracked and correlated with the detection of various events of which the user may need to be informed (e.g., the nearest location for resources such as water or shelter, or the nearby detection of a potentially dangerous wild animal). In some examples, the aggregated information may be used to formulate a response to an explicit user query, while in other examples the aggregated information may be utilized to formulate proactive alerts for the user's safety. Examples of the present disclosure could also be used to facilitate responses by emergency personnel in areas where Internet connectivity may be limited or access to specific locations may be challenging. These and other aspects of the present disclosure are described in greater detail below in connection with the examples of FIGS. 1-3.

To further aid in understanding the present disclosure, FIG. 1 illustrates an example system 100 in which examples of the present disclosure may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, and the like), a long term evolution (LTE) network, 5G and the like related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a network 102, e.g., a telecommunication service provider network, a core network, or an enterprise network comprising infrastructure for computing and communications services of a business, an educational institution, a governmental service, or other enterprises. The network 102 may be in communication with one or more access networks (e.g., access network 120) and the Internet (not shown). In one example, network 102 may combine core network components of a cellular network with components of a triple play service network; where triple-play services include telephone services, Internet or data services and television services to subscribers. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over internet Protocol (VoIP) telephony services. Network 102 may further comprise a broadcast television network, e.g., a traditional cable provider network or an internet Protocol Television (IPTV) network, as well as an Internet Service Provider (ISP) network. In one example, network 102 may include a plurality of television (TV) servers (e.g., a broadcast server, a cable head-end), a plurality of content servers, an advertising server (AS), an interactive TV/video on demand (VoD) server, and so forth.

In one example, the access network 120 may comprise a broadband optical and/or cable access network, a Local Area Network (LAN), a wireless access network (e.g., an IEEE 802.11/Wi-Fi network and the like), a cellular access network, a Digital Subscriber Line (DSL) network, a public switched telephone network (PSTN) access network, a 3^{rd} party network, and the like. For example, the operator of network 102 may provide a cable television service, an IPTV service, or any other types of telecommunication service to subscribers via access network 120. In one example, the network 102 may be operated by a telecommunication network service provider. The network 102 and the access networks 120 may be operated by different service providers, the same service provider or a combination thereof, or may be operated by entities having core businesses that are not related to telecommunications services, e.g., corporate, governmental or educational institution LANs, and the like.

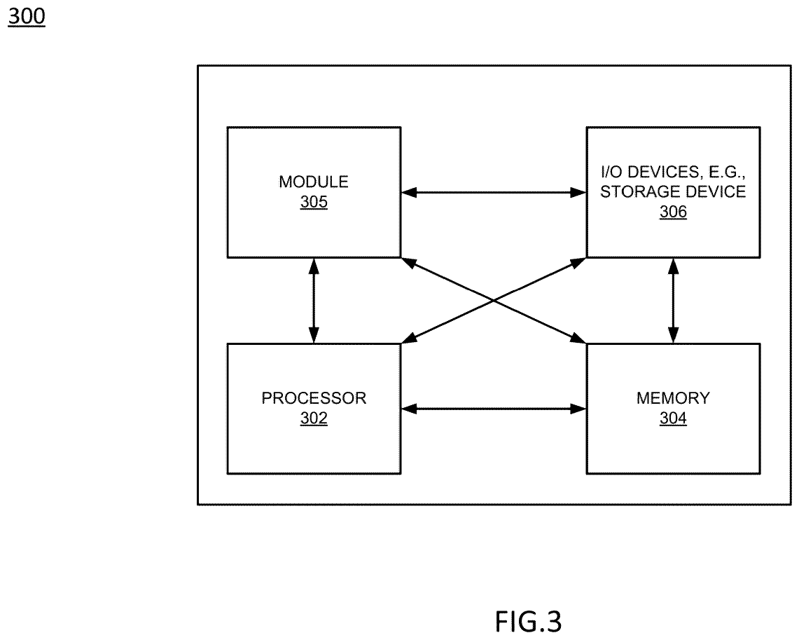

In accordance with the present disclosure, network 102 may include an application server (AS) 104, which may comprise a computing system or server, such as computing system 300 depicted in FIG. 3, and may be configured to provide one or more operations or functions in connection with examples of the present disclosure for integrating and aggregating data from a plurality of distributed sensors. The network 102 may also include one or more databases (DBs) 1061-106N (hereinafter individually referred to as a “DB 106” or collectively referred to as “DBs 106”) that are communicatively coupled to the AS 104. For instance, one of the DBs 106 may contain digital resources (e.g., maps, weather forecasts, etc.), while another of the DBs 106 may contain user profiles for users of a service that integrates and aggregates data from a plurality of distributed sensors, and another of the DBs 106 may contain other data.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure. Thus, although only a single application server (AS) 104 and two databases (DBs) 106 are illustrated, it should be noted that any number of servers and any number of databases may be deployed. Furthermore, these servers and databases may operate in a distributed and/or coordinated manner as a processing system to perform operations in connection with the present disclosure.

In one example, AS 104 may comprise a centralized network-based server for providing access to downloadable digital resources. For instance, the AS 104 may host search engine through which a user may enter one or more keywords to search one or more databases (e.g., DBs 1061-106N, hereinafter collectively referred to as “DBs 106” or individually referred to as a “DB 106”). The DBs 106 may store various digital resources relating to a plurality of locations, where the digital resources may comprise information that may allow a user to navigate within a location (e.g., to find their way to and from specific locations as well as to find physical resources such as water, shelter, food, network connectivity, and the like). For instance, the digital resources may include maps, geographic information system (GIS) data, global positioning system (GPS) data, and the like. The maps may indicate not just roads and trails, but also topography, locations of known hazards (e.g., areas at risk of mudslides, steep ascents, rough waters, or the like), locations of known resources (e.g., telephones, drinking water stations, shelter, etc.), variations in cellular and/or WiFi coverage, and the like.

Thus, in one example, one or more of the DBs 106 may store the digital resources, and the AS 104 may retrieve or search the DBs 106 for digital resources that match a user query (e.g., by matching user-defined keywords to metadata associated with the digital resources). The AS 104 may provide, in response to the user query, a list of digital resources that match the query along with locations (e.g., DBs 106) from which each digital resource on the list may be downloaded. In another example, AS 104 may comprise a physical storage device (e.g., a database server) to store the digital resources. For ease of illustration, various additional elements of network 102 are omitted from FIG. 1.

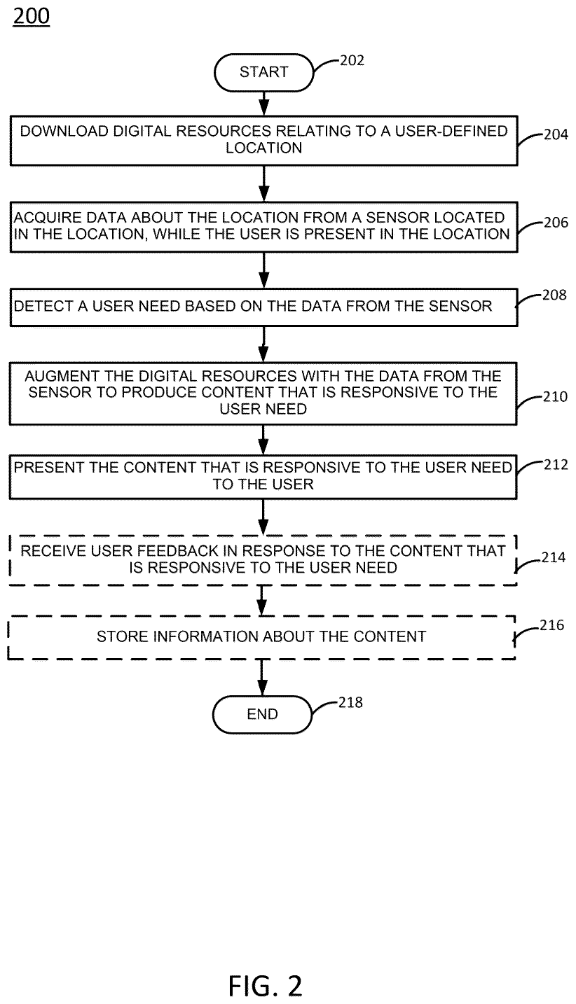

In one example, access network 120 may include an edge server 108, which may comprise a computing system or server, such as computing system 300 depicted in FIG. 3, and may be configured to provide one or more operations or functions for integrating and aggregating data from a plurality of distributed sensors, as described herein. For instance, an example method 200 for integrating and aggregating data from a plurality of distributed sensors is illustrated in FIG. 2 and described in greater detail below.

In one example, application server 104 may comprise a network function virtualization infrastructure (NFVI), e.g., one or more devices or servers that are available as host devices to host virtual machines (VMs), containers, or the like comprising virtual network functions (VNFs). In other words, at least a portion of the network 102 may incorporate software-defined network (SDN) components. Similarly, in one example, access network 120 may comprise an “edge cloud,” which may include a plurality of nodes/host devices, e.g., computing resources comprising processors, e.g., central processing units (CPUs), graphics processing units (GPUs), programmable logic devices (PLDs), such as field programmable gate arrays (FPGAs), or the like, memory, storage, and so forth. In an example where the access network 120 comprises a radio access network, the nodes and other components of the access network 120 may be referred to as a mobile edge infrastructure. As just one example, edge server 108 may be instantiated on one or more servers hosting virtualization platforms for managing one or more virtual machines (VMs), containers, microservices, or the like. In other words, in one example, edge server 108 may comprise a VM, a container, or the like.

In one example, the access network 120 may be in communication with one or more devices, including a user endpoint device 112. Access network 120 may transmit and receive communications between user endpoint device 112 application server (AS) 104, other components of network 102, devices reachable via the Internet in general, and so forth. In one example, the user endpoint device 112 may comprise a mobile device, a cellular smart phone, a wearable computing device (e.g., smart glasses, a virtual reality (VR) headset or other type of head mounted display, or the like), a laptop computer, a tablet computer, an Internet of Things (IoT) device, or the like. In addition, the user endpoint device 112 may include one or more integrated sensors, including a camera, a microphone, a GPS system, a biometric sensor, and/or the like. In one example, the user endpoint devices 112 may comprise a computing system or device, such as computing system 300 depicted in FIG. 3, and may be configured to provide one or more operations or functions in connection with examples of the present disclosure for integrating and aggregating data from a plurality of distributed sensors.

The system 100 may further include a plurality of sensors 114₁-114_{M} (hereinafter collectively referred to as “sensors 114” or individually referred to as a “sensor 114”). In one example, the sensors 114 may be distributed throughout a location (e.g., a local or national park, a city, a landmark, or the like) and may be configured to collect real time information about the location. For instance, in one example, the sensors 114 may include weather sensors, thermometers, barometric pressure sensors, humidity sensors, cameras, microphones, motion sensors, beacons, and the like. The sensors 114 may be mounted to trees, trail markers, buildings, drones or other mobile devices or vehicles, and/or other surfaces or structures. In a further examples, some of the sensors 114 may include tracking devices (e.g., radio collars or tags or the like) affixed to wild animals.

In a further example, the sensors 114 may include sensors that observe the location from a distance, such as satellites, long range cameras, drones, and the like. The sensors 114 may be connected to an access network (e.g., access network 120 or another access network) via cellular, WiFi, or other communication means, and may provide readings to the one or more of the DBs 106 for storage. Alternatively or in addition, the sensors 114 may be capable of short-range communication, such as communication via near field communication, Bluetooth, RFID, or other proximity based communication protocols. In this respect, the sensors 114 may be capable of communicating directly with the user endpoint device 112 (or other user endpoint devices) when the user endpoint device 112 is within communication range. In a further example, at least some of the sensors 114 may be capable of communicating with each other.

In an illustrative example, a system for integrating and aggregating data from a plurality of distributed sensors to enhance human awareness of surroundings and conditions may be provided via AS 104, DBs 106, sensors 114, and user endpoint device 112. In one example, a user may engage an application on user endpoint device 112 to establish one or more sessions with the system, e.g., a connection to edge server 108 (or a connection to edge server 108 and a connection to AS 104). In one example, the access network 120 may comprise a cellular network (e.g., a 4G network and/or an LTE network, or a portion thereof, such as an evolved Uniform Terrestrial Radio Access Network (eUTRAN), an evolved packet core (EPC) network, etc., a 5G network, etc.). Thus, the communications between user endpoint device 112 and edge server 108 may involve cellular communication via one or more base stations (e.g., eNodeBs, gNBs, or the like). However, in another example, the communications may alternatively or additional be via a non-cellular wireless communication modality, such as IEEE 802.11/Wi-Fi, or the like. For instance, access network 120 may comprise a wireless local area network (WLAN) containing at least one wireless access point (AP), e.g., a wireless router. Alternatively, or in addition, user endpoint device 112 may communicate with access network 120, network 102, the Internet in general, etc., via a WLAN that interfaces with access network 120.

In the example of FIG. 1, user endpoint device 112 may establish a session with edge server 108 for downloading one or more digital resources associated with a location (e.g., a user-defined location). The location may be, for example, a location that the user is planning to visit (but is not currently at the location) and at which the user expects to have unreliable access to Internet connectivity. For instance, the location may be a remote forested or mountainous location. The digital resources may comprise static information about the location, such as maps, geographic information system (GIS) data, global positioning system (GPS) data, and the like. The user may download the digital resources at a time when the user has reliable access to Internet connectivity (e.g., while the user is at home, at a hotel, at a visitor center or other facility with WiFi access, or the like).

As an example, a user may be planning to visit a national park and may download a trail map 116 of the national park to the user's mobile phone (e.g., user endpoint device 112). However, as discussed above, the Internet connectivity within the national park may be unreliable and/or inconsistent, which may pose a safety hazard for the user. For instance, if the user becomes lost, runs out of water, encounters a wild animal, suffers an injury, or the like, it may be difficult for the user to obtain help without a reliable means of communicating or accessing information.

In the example illustrated in FIG. 1, the user endpoint device 112 may obtain dynamic information about the location from one or more sensors 114 that are distributed throughout the location. For instance, when the user endpoint device 112 is within proximity of a sensor 114 that communicates via a short-range communication protocol, the user endpoint device 112 may be able to download the dynamic data from the sensor 114. The dynamic data may include images, thermometer readings, motion sensor readings, and the like. For instance, in the example illustrated in FIG. 1, the dynamic data may include a photograph 118 of a mountain lion that was detected by a camera within the location. The photograph may be associated with metadata indicating a location (e.g., GPS coordinates) of the camera that captured the image, a time and/or date at which the image was captured, and/or other information (e.g., information about the captured subject such as how to behave when encountering a mountain lion).

The user endpoint device 112 may use the dynamic sensor data to augment the digital resources that were previously downloaded. For instance, the user endpoint device may correlate the dynamic sensor data with the digital resources and/or with other data (e.g., data collected from sensors integrated into the user endpoint device 112) in order to predict a user need. For instance, the user endpoint device 112 may correlate the location of the mountain lion (obtained from the metadata associated with the photograph 118) with information about the trail that the user is planning to hike (obtained from the trail map 116) and determine that the mountain lion is somewhere on the trail that the user was planning to hike. The user endpoint device 112 may even be able to pinpoint an approximate location of the user on the trail based on data collected from other sensors 114, such as a photograph of the user by a camera having a known location or coordinates (e.g., mile X on Trail Y) or a proximity-based interaction of the user endpoint device 112 with a beacon having a known location or coordinates. In this case, the user endpoint device 112 may be able to estimate how far the mountain lion sighting is from the user's current location on the trail. Based on this correlation, the user endpoint device 112 may predict that the user need comprises a need to be informed about the presence of the mountain lion on the trail that the user is hiking.

In one example, the user endpoint device 112 may generate content that is responsive to the user need. The content may be based on the digital resources and/or the sensor data. For instance, in the above example, the content may comprise an alert to notify the user of the potential presence of the mountain lion on the trail that the user is hiking and/or to advise the user to turn around, look for shelter, or take another trail. In this case, the alert could take the form of an augmented map 110. The augmented map 110 may display at least a portion of the map 116 (e.g., at least a portion of the map 116 showing the trail that the user is hiking). The augmented map may include a marker 122 to indicate the location of the potential hazard, e.g., mountain lion. However, in other examples, the alert may take other forms. For instance, the alert may comprise a text alert notifying the user of the presence of a mountain lion some distance ahead on the trail and a recommendation as to how to avoid the mountain lion (e.g., turn around, look for shelter, take another trail, etc.) or how to behave if the user encounters the mountain lion (e.g., don't approach, don't run, make loud noise, etc.). In another example, the alert may take the form of an extended reality environment for display on the user endpoint device 112. For instance, the extended reality environment may superimpose a digital image of a mountain lion or a marker over the user's view of the trail through a pair of smart glasses, where the digital image may be positioned to indicate the estimated position of the mountain lion.

In another example, the alert may be stored and only activated when the user is in proximity to the alert area or region associated with the alert. For instance, the updated marker 122 may be sent to the augmented map 110, but no alert may be immediately triggered. Instead, the alert may only be triggered when or if the user is within some threshold distance (e.g., one hundred feet or yards) of the last known location of the mountain lion (where the last known location is based on a location of a camera that captured an image of the mountain lion, a GPS sensor attached to a collar on the mountain lion, or the like). At this time, the alert may be generated as an audible or visible alert (e.g., a passive notification), as navigational instructions to move the user away from the last known location of the mountain lion (e.g., joint guidance of the user), or the alert may signal other users of user endpoint devices in the area (such as park rangers) on behalf of the user (e.g., as an automated action taken on the user's behalf). In another example, the signaling of others on behalf of the user may be preemptively executed when the user is within proximity of network access (e.g., access network 120), such that a predicted intersection of the danger location and the user is part of the alert.

It should be noted that the system 100 has been simplified. Thus, it should be noted that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of network 102, access network 120, and/or Internet may comprise a content distribution network (CDN) having ingest servers, edge servers, and the like for packet-based streaming of video, audio, or other content. Similarly, although only one access network 120 is shown, in other examples, the access network 120 may comprise a plurality of different access networks that may interface with network 102 independently or in a chained manner. In addition, as described above, the functions of AS 104 may be similarly provided by server 108, or may be provided by AS 104 in conjunction with server 108. For instance, AS 104 and server 108 may be configured in a load balancing arrangement, or may be configured to provide for backups or redundancies with respect to each other, and so forth. Thus, these and other modifications are all contemplated within the scope of the present disclosure.

To further aid in understanding the present disclosure, FIG. 2 illustrates a flowchart of an example method 200 for integrating and aggregating data from a plurality of distributed sensors to enhance human awareness of surroundings and conditions in accordance with the present disclosure. In one example, the method 200 may be performed by a user endpoint device that executes a software application for integrating and aggregating data from a plurality of distributed sensors, such as the UE 112 illustrated in FIG. 1. However, in other examples, the method 200 may be performed by another device, such as the processor 302 of the system 300 illustrated in FIG. 3. For the sake of example, the method 200 is described as being performed by a processing system.

The method 200 begins in step 202. In step 204, the processing system may download digital resources relating to a user-defined location. The user may define the location using a user endpoint device (e.g., a mobile phone, a tablet computer, a laptop computer, a virtual assistant, or the like) that is in communication with the processing system.

In one example, the user may define the location by explicitly naming the location (e.g., by speaking the name of the location, typing the name of the location, selecting the location from a menu on a display, providing GPS (global positioning system) coordinates of the location, or the like). For instance, the user may type “Joshua Tree National Park” into a search bar on the user's mobile phone. In this case, the user may not yet be at the location for which the digital resources are being downloaded when the user specifies the location. For instance, the user may be planning to hike in a remote area where Internet connectivity may be uncertain or unreliable, and may be attempting to collect information about the area before arriving in the area (e.g., while the user is at home with reliable Internet connectivity).

However, in other examples, the user may be at the location for which the digital resources are being downloaded when the user specifies the location. In this case, the location could also be specified by simply requesting that the processing system downloads digital resources for the user's current location, where the processing system is able to identify the user's current location by obtaining data from one or more sensors in communication with the processing system. For instance, global positioning sensors or other types of sensors integrated into the user's mobile phone could communicate the coordinates of the user's current location to the processing system. In some examples, the ability to download digital resources while the user is present in the specified location may be limited by the network conditions in the specified location (e.g., how strong and consistent the cellular or WiFi connectivity is).

In one example, the digital resources that the processing system downloads may include resources relating to the specified location that will help the user to navigate and remain safe within the specified location. For instance, the digital resources may include maps, geographic information system (GIS) data, GPS data, and the like. The maps may indicate not just roads and trails, but also topography, locations of known hazards (e.g., areas at risk of mudslides, steep ascents, rough waters, or the like), locations of known resources (e.g., telephones, drinking water stations, shelter, etc.), variations in cellular and/or WiFi coverage, and the like.

In step 206, the processing system may acquire data about the location from a sensor located in the location, while the user is present in the location. In other words, while the user is present in the location, the processing system may detect one or more sensors that are present in the location and may acquire real time information about the location from those sensors. In one example, at least some of the sensors may be capable of communicating with the processing system using short range wireless communication protocols such as near field communication, Bluetooth, radio frequency identification (RFID), and/or other protocols that do not require cellular or WiFi connectivity. Thus, the sensors may be within detection range of the processing system.

In one example, the one or more sensors may include sensors that are integrated into devices belonging to the user and/or into user endpoint devices carried by other individuals who are present in the location. For instance, the sensors may include or be integrated into a mobile phone, a smart watch, a fitness tracker, a GPS system, or the like that the user is carrying in the location. The sensors that are integrated into the devices belonging to the user may transmit data to the processing system on a continuous and/or periodic basis. In one example, the data that the processing system may acquire from the sensors that are integrated into the devices belonging to the user may include user biometric data (e.g., readings of body temperature, heart rate, skin conductivity, etc.), environmental condition data (e.g., readings of temperature, humidity, etc.) for the location, user position within the location (e.g., the precise coordinates of the user's position, e.g., GPS coordinates), images of the user and/or the location, audio of the user and/or the location, and/or other data.

In a further example, the one or more sensors may include sensors that are distributed throughout the location and/or sensors that are positioned to observe the location from a distance. For instance, the sensors that are distributed throughout the location may include weather sensors, thermometers, barometric pressure sensors, humidity sensors, cameras, microphones, motion sensors, beacons, wildlife tracking devices (e.g., radio collars or tags), and the like. Sensors that are positioned to observe the location from a distance may include satellites, long range cameras, drones, and the like.

In step 208, the processing system may detect a user need based on the data from the sensor. The user need may be detected by processing the data from the sensor using one or more data processing techniques. For instance, audio data could be processed to recognize sounds or words occurring in the audio data (e.g., using speech to text transcription techniques or similar techniques). The recognized sounds or words could be further processed to extract meaning (e.g., using natural language understanding or similar techniques). Data that is received as text may be similarly processed to extract meaning such as intent detection and name entity extraction. Image data (e.g., still images) could be processed to recognize people and objects (e.g., using facial recognition techniques, object recognition techniques, text recognition techniques, and similar techniques) appearing in the image data. Video data can be used for tracking and to infer people and object actions, such as running and jumping. Sensor readings such as temperature readings, motion sensor readings, and the like could be compared to predefined threshold readings, where the threshold readings may indicate safety limits (e.g., a maximum amount of time for which a human can safely withstand exposure to a specified ultraviolet index without experiencing sunburn).

In one example, the user need may be an immediate need of the user (e.g., a need that is expected at the present time based on current conditions and/or context) or a predicted need of the user (e.g., a need that is expected at a future time based on current conditions and/or context). For instance, if a microphone on the user's mobile phone detects the user saying that they are running low on drinking water, the processing system may infer that the user is in immediate need of navigation to the nearest water station (or any other locations where the user can potentially obtain more drinking water, e.g., wells, streams, rivers, etc.). Alternatively, if a camera detects the presence of a potential hazard (e.g., a wild animal, a rockslide, or the like) a mile further up a path that the user appears to be following, then the processing system may infer that the user is in need of navigation to avoid the potential hazard in the future (e.g., to turn back or to take an alternate path).

In one example, the user need may be detected based on knowledge of the user, which may be stored in a user profile. For instance, the processing system may detect that the current conditions in the user's vicinity are atypical for the user. As an example, the user may live in a tropical climate, but may currently be visiting a tundra environment. In this case, the processing system may infer that the user is not familiar with the symptoms of hypothermia and may need to be informed of the symptoms and/or steps for preventing hypothermia. Thus, the user need can be categorized into different classes of needs, e.g., navigation need (a need for navigational information to reach a location, avoid a location, or to reach a location having a particular needed resource), medical information need (a need for medical information for detecting and/or treating a particular medical condition), environmental warning need (a need for warning of a particular weather situation affecting a particular geographical location, or a wild animal situation affecting a particular geographical location), personal physical need (a physical need of the body such as rest, water or food), and so on.

In step 210, the processing system may augment the digital resources with the data from the sensor to produce content (e.g., informational content) that is responsive to the user need. The augmentation may be performed online or offline (depending on the ability of the processing system to obtain a reliable signal). For instance, the processing system may perform the augmentation using stratosphere-based connectivity (e.g., through geosynchronous equatorial orbit satellites, low earth orbit satellites, or the like) or connectivity enabled through immediately proximal network nodes (e.g., embedded towers, backhaul portions of a mobile network, or the like).

In one example, the content may comprise visual content that may be displayed to the user (e.g., a map, text instructions, images, video, or the like), audio content that may be played back to the user (e.g., synthesized speech, an alarm, or the like), and/or other content that may be presented to the user via other modalities.

As an example, if the user need comprises a need to be informed of the presence of a wild animal in the user's vicinity (e.g., detected through object recognition processing of video of the animal and/or signal processing of radio signals from the user's mobile phone), then the processing system may augment a downloaded map of the user's vicinity with tracking information to show the location and trajectory of the wild animal. If the user need comprises a need to obtain drinking water (e.g., detected through natural language processing of audio of the user saying they are running out of drinking water), then the processing system may augment a downloaded map of the user's vicinity with navigation to the nearest source of drinking water (e.g., a water station, a shelter building, a natural body of water, or the like). If the user need comprises a need to be familiarized with the warning signs of hypothermia (e.g., detected based on thermometer readings from the user's vicinity showing sub-freezing temperatures and knowledge that the user resides in a tropical climate where there is low risk of hypothermia), then the processing system may provide a text message or a video or a link to a web site explaining the warning signs. If the user need comprises a need to communicate with another party (e.g., detected through natural language processing of audio of the user saying they need to send a text message and detection of weak cellular and WiFi signals in the user's vicinity), then the processing system may provide text or audio instructions or a map instructing the user on how to connect to a proximal sensor (e.g., an IoT device, a drone, or the like) that can extend cellular or WiFi network capabilities and/or create a relay with other devices to facilitate communication. If the user need comprises a need to avoid imminent inclement weather (e.g., detected based on processing of sensor readings from one or more weather sensors and processing of GPS readings from the user's mobile phone), then the processing system map provide a map displaying a route to a nearest shelter building. If the user need comprises a need for the user to rest (e.g., detected based on processing of user heartrate readings provided by the user's fitness tracker), then the processing system may provide a text or audio notification advising the user to stop and rest.

In another example, the user need may exceed the capabilities of one sensor alone, thus requiring the coordination of multiple sensors or multiple data payloads (e.g., both static and dynamic data). For instance, the user need may be to avoid avalanche locations while in snow-covered areas. While sensors (e.g., microphones) mounted in ambient locations may detect preconditions of avalanches (e.g., sliding noises, cracking, etc.), the processing system may coordinate the sensor combination of audio to better triangulate and differentiate the sounds. For instance, by combining data from both the user's local microphone (e.g., integrated in the user's mobile phone) and the microphones mounted in the ambient locations, a higher fidelity signal (e.g., the sound) and more specific location may be detected via on-device or edge-based signal aggregation and processing. In another example, during the operation of this combination of microphones, the processing system may request that the user orient his or her mobile phone in a certain direction, height, or the like to acquire better sensor data for aggregation. In yet another example, the augmenting of digital resources can also be a distributed task. For instance, rather than a mobile phone, the user endpoint device may be a simple biometric watch or pulse tracking device that has limited compute or memory storage. However, continuing the scenario from above, the user need for detecting an avalanche requires triangulation of aural and visual data to detect developing avalanche conditions. If the capabilities are available, the processing system could coordinate the aggregation and compute the warning on remote sensors and return the result to the user's simple user endpoint device.

In step 212, the processing system may present the content that is responsive to the user need to the user. As discussed above, in one example, the content may comprise visual content that may be displayed to the user (e.g., a map, text instructions, images, video, or the like), audio content that may be played back to the user (e.g., synthesized speech, an alarm, or the like), and/or other content that may be presented to the user via other modalities.

In one example, the nature of the content, and the modality through which the content is presented, may be based on information from a user profile, on current user context, and/or on the capabilities of the user endpoint devices that the user currently has on his or her person. For instance, if a user profile for the user indicates that the user has a visual impairment, then the content may comprise audio content that is played through a speaker controlled by the processing system. Similarly, if the current user context indicates that the user is currently running (or is otherwise unable to look at a screen), then the content may comprise audio content that is played through a speaker controlled by the processing system. If the user is currently wearing a set of smart glasses, then the content may comprise visual content that is sent by the processing system to the display of the smart glasses.

In another example, the visual impairment may be utilized by the system and trigger an additional execution of step 208 to detect a further user need based on potential hazards that are adjacent to the user or that are approaching on the user's navigational path. This visual impairment (and the re-executed user need detection) may also be detected during the course of operation of the method 200 due to unusual weather conditions, an injury sustained by the user, or other temporary or instantaneous events.

In optional step 214 (illustrated in phantom), the processing system may receive user feedback in response to the content that is responsive to the user need. For instance, in one example, the content may be presented as a dialog through which the processing system may interact with the user. As an example, the content may comprise a query that is posed to the user, such as a text-based alert that asks when the user last applied sunscreen. In this case, the alert may expect or require a response from the user in order to dismiss the alert, reset a timer that triggers the alert, or otherwise determine that the user need has been met.

In another example, the user may ask a question in response to being presented with the content that is responsive to the user need. For instance, in response to being presented with a map that illustrates a path to the nearest source of drinking water, the user may ask out loud, “Am I walking in the right direction?” In response to being presented with a notification that a wild animal has been detected in the area, the user may click a hyperlink in the notification that directs the user to a website detailing what to do if such a wild animal is encountered.

In optional step 216 (illustrated in phantom), the processing system may store information about the content. In one example, storing information about the content may include updating one or more of the digital resources to reflect the content. For instance, a map of a location could be updated to indicate that a particular type of wild animal has been detected repeatedly within a certain geographic radius. In another example, storing information about the content may include updating a sensor or beacon to reflect the content. For instance, if the processing system determines through interaction with a user that a particular shelter building has been structurally damaged, then beacons in the vicinity of the shelter building may be updated so that other users are directed away from the damaged shelter building (or towards different shelter buildings).

The method 200 may end in step 218. However, in some examples, steps of the method 200 (e.g., any one or more of steps 204-216) may be repeated until the user asks the processing system to terminate the method 200 (e.g., by closing an application that executes the method 200, powering down a device that runs the application, or the like). For instance, for as long as the user is present in the location, the method 200 may continue to acquire data about the location from sensors as the user moves through the location, and may continue to detect and respond to user needs that are inferred based on the data.

Thus, examples of the present disclosure remove the burden on users to discover and aggregate sensor data on their own. For instance, a user who is hiking in a remote location will not need to locate all of the weather stations and wireless access points ahead of their hike. Instead, examples of the disclosure discover and aggregate data from useful sensors automatically, working with both local and remote services to assist the user in retrieving data and updating the data over time and across locations. Having the data discovered and aggregated and on hand during the hike can help the user to make decisions without jeopardizing his or her safety (e.g., whether a specific trail can be completed in a limited amount of daylight time or without access to further water sources). Moreover, the ability to monitor user progress and conditions over time allows examples of the present disclosure proactively alert the user to potential hazards and safety risks, such as sudden weather conditions, health-related emergencies, encounters with wild animals, and the like.

Although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

The ability to integrate and aggregate data from a plurality of distributed sensors may enhance human awareness in a variety of situations. For instance, in one example, examples of the present disclosure may be used to enhance the awareness of users who venture into geographic areas where Internet connectivity may be limited or unavailable. For instance, a user who is hiking in a remote forested or mountainous area may utilize examples of the present disclosure to obtain enhanced viewing of the area, discovery nearby resources (e.g., water, shelter, connectivity to communications, etc.). Thus, the user may feel and be safer when venturing into the geographic area. In addition, examples of the present disclosure may improve the safety of wildlife living in the geographic area as well as human visitors. For instance, examples of the present disclosure could generate alerts to instruct the user to avoid or give a specified degree of space to certain areas where wildlife are known to live or be active (e.g., sea turtle nesting areas, habitats of threatened and/or endangered species, etc.).

Examples of the present disclosure could also be used to address user queries in such situations. For instance, a user may ask, “Can I make it across that mountain ridge in four hours?” In this case, examples of the present disclosure may analyze the query in light of aggregated data, knowledge of the user (e.g., obtained from a user profile), and the like. For instance, knowing the distance across and the topology of the mountain ridge (which may be acquired from downloaded maps, including topological maps), the speed of the user on the terrain (which may be acquired from a fitness tracker worn by the user and/or from local sensors that have tracked the user in the area), and any hazards present on the mountain ridge (which may be acquired from sensors placed to observe portions of the mountain ridge), examples of the present disclosure may be able to formulate a response to the query.

In further examples, examples of the present disclosure may be implemented in the form of a virtual assistant which may predict user needs and responsively guide the user based on the predicted needs. For instance, a virtual assistant could correlate the dietary needs (e.g., vegetarian, diabetic, allergies, etc.) of a user who is traveling with knowledge of the food options that are available at rest stops along the user's route and the user's speed of travel. The virtual assistant may make suggestions as to when and where the user might stop to eat a meal. The virtual assistant could also alert the user when the user travels out of range of stable Internet connectivity.

Further examples of the present disclosure could be used to enhance tourism applications and virtual tours of cities, landmarks, museums, and the like. For instance, examples of the present disclosure could be implemented in conjunction with immersive applications that display images of a location (e.g., a city, a landmark, a museum, or the like) on a head mounted display, a mobile phone, a tablet computer, or the like. As an example, by aggregating downloaded resources with more current sensor data, examples of the present disclosure may be able to present an enhanced experience (e.g., by replacing ambient noise with other sounds, removing views of scaffolding, trash, or the like, improving lighting in low-lit areas to improve visibility, etc.).

Further examples of the present disclosure could be used to assist first responders, military personnel, and other emergency personnel. For instance, examples of the present disclosure could help to identify the best avenues for delivery of aid (e.g., water, fire suppression materials, etc.) in remote areas, areas where natural or other disasters have struck, and the like. In some examples, specialized sensors could be deployed in areas that are known to be prone to certain types of conditions to further assist in emergencies. For instance, specialized sensors could be deployed to monitor for air quality or radioactivity. Other specialized sensors might have enhanced visual capabilities (e.g., long range vision, night vision, etc.) and/or persistent connections to satellite resources.

Further examples of the present disclosure could be used to implement automated features that send enhanced requests for assistance when emergency situations are detected. For instance, when certain conditions are detected or certain keywords are spoke by a user, examples of the present disclosure could be used to activate the launch of a balloon or a flare (e.g., from a beacon or a drone).

Further examples of the present disclosure could be integrated with sensoring in apparel or outdoors equipment (e.g., tent, sleeping bag, etc.) to monitor user biometrics and responsively request help when the biometrics indicate a potential emergency (e.g., dehydration, low blood sugar, hypothermia, etc.). Requests for help may identify the specific conditions that triggered the requests, user locations, and/or other information.

Further examples of the present disclosure may communicatively connect to existing emergency signal and notification channels. For instance, examples of the present disclosure could transmit information over frequency modulation (FM) radio frequencies, but include data payloads for preemptive communication.

Examples of the present disclosure could also be extended to assist with the discovery of wireless charging access points in a user's vicinity. For instance, examples of the present disclosure could connect to cellular base stations and/or other services that may offer connectivity and preemptive wireless charging, maximizing the user's ability to access digital resources.

Further extensions of the present disclosure may be used to activate certain capabilities in distributed sensors. For instance, in emergency situations, detection capabilities in sensors or drones may be activated to collect information about a user in distress, and this information may be provided to emergency personnel to enable more targeted assistance to the user.

Further extensions of the present disclosure could be used to provide emergency assistance to users living in areas that are prone to certain dangerous conditions. For instance, in areas that are prone to earthquakes, examples of the present disclosure could be used to provide real time access to the safest or quickest escape routes and sources of resources. Emergency personnel could utilize such a system to customize monitoring and alerting of emergencies for specific locations.

Further extensions of the present disclosure may be used to help plan for activities and events. For instance, integration of data from digital resources and sensors may help examples of the present disclosure to assist a user who is packing for a trip or an excursion. Examples of the present disclosure may recommend apparel and items to bring or not bring (e.g., if the user is traveling to a cold environment for the first time, remind the user to pack weather-appropriate clothing; if cloudy conditions are predicted, recommend that the user bring a spare device battery since solar powered charging may be unreliable).

Further extensions of the present disclosure could integrate communication with user devices that perform advanced functions. For instance, if the user is detected to be at risk of frostbite, examples of the present disclosure could send an instruction to a system that activates warming of the user's clothing via kinetics.

FIG. 3 depicts a high-level block diagram of a computing device specifically programmed to perform the functions described herein. For example, any one or more components or devices illustrated in FIG. 1 or described in connection with the method 200 may be implemented as the system 300. For instance, a server (such as might be used to perform the method 200) could be implemented as illustrated in FIG. 3.

As depicted in FIG. 3, the system 300 comprises a hardware processor element 302, a memory 304, a module 305 for integrating and aggregating data from a plurality of distributed sensors, and various input/output (I/O) devices 306.

The hardware processor 302 may comprise, for example, a microprocessor, a central processing unit (CPU), or the like. The memory 304 may comprise, for example, random access memory (RAM), read only memory (ROM), a disk drive, an optical drive, a magnetic drive, and/or a Universal Serial Bus (USB) drive. The module 305 for integrating and aggregating data from a plurality of distributed sensors may include circuitry and/or logic for performing special purpose functions relating to the operation of a user endpoint device. The input/output devices 306 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for integrating and aggregating data from a plurality of distributed sensors (e.g., a software program comprising computer-executable instructions) can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for integrating and aggregating data from a plurality of distributed sensors (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
downloading, by a processing system including at least one processor, at least one digital resource relating to a user-defined location;
acquiring, by the processing system, data about the user-defined location from a sensor located in the user-defined location, while the user is present in the user-defined location;
detecting, by the processing system, a user need based on the data from the sensor;
augmenting, by the processing system, the at least one digital resource with the data from the sensor to produce content that is responsive to the user need; and
presenting, by the processing system, the content that is responsive to the user need.

2. The method of claim 1, wherein the user-defined location comprises a location in which internet connectivity is known to be unreliable.

3. The method of claim 1, wherein the downloading is performed while the user is at a location other than the user-defined location for which the at least one digital resource is being downloaded.

4. The method of claim 1, wherein the at least one digital resource comprises static information about the user-defined location.

5. The method of claim 4, wherein the static information comprises at least one of: a map, geographic information system data, or global positioning system data.

6. The method of claim 5, wherein the map indicates at least one of: locations of roads in the user-defined location, locations of trails in the user-defined location, topography of the user-defined location, locations of known hazards in the user-defined location, or locations of known resources in the user-defined location.

7. The method of claim 1, wherein the data about the user-defined location that is acquired from the sensor comprises real time information about the user-defined location.

8. The method of claim 1, wherein the sensor communicates with the processing system using a short range wireless communication protocol.

9. The method of claim 8, wherein the processing system downloads the at least one digital resource over a connection to an access network.

10. The method of claim 1, wherein the sensor is integrated into a user endpoint device including the processing system.

11. The method of claim 10, wherein the data about the user-defined location comprises at least one of: biometric data of the user, environmental condition data for the user-defined location, a user position within the user-defined location, an image of the user, an image of the user-defined location, audio of the user, or audio of the user-defined location.

12. The method of claim 1, wherein the sensor is one of a plurality of sensors that is distributed throughout the user-defined location.

13. The method of claim 12, wherein the sensor comprises at least one of: a weather sensor, a thermometer, a barometric pressure sensor, a humidity sensor, a camera, a microphone, a motion sensor, a beacon, or a wildlife tracking device.

14. The method of claim 1, wherein the sensor is positioned to observe the user-defined location from a distance.

15. The method of claim 14, wherein the sensor comprises at least one of: a satellite, a long range camera, or a drone.

16. The method of claim 1, wherein the content comprises at least one of: a map, a text instruction, an image, a video, a synthesized speech, an alarm, or an extended reality content.

17. The method of claim 1, wherein the content comprises an interactive dialog, and the method further comprises:
receiving, by the processing system, user feedback in response to the content that is responsive to the user need.

18. The method of claim 1, wherein the data about the user-defined location is obtained from a plurality of sensors including the sensor and aggregated by the processing system to detect the user need.

19. A non-transitory computer-readable medium storing instructions which, when executed by a processing system including at least one processor, cause the processing system to perform operations, the operations comprising:
downloading at least one digital resource relating to a user-defined location;
acquiring data about the user-defined location from a sensor located in the user-defined location, while the user is present in the user-defined location;
detecting a user need based on the data from the sensor;
augmenting the at least one digital resource with the data from the sensor to produce content that is responsive to the user need; and
presenting the content that is responsive to the user need.

20. A device comprising:
a processing system including at least one processor; and
a computer-readable medium storing instructions which, when executed by the processing system, cause the processing system to perform operations, the operations comprising:
downloading at least one digital resource relating to a user-defined location;
acquiring data about the user-defined location from a sensor located in the user-defined location, while the user is present in the user-defined location;
detecting a user need based on the data from the sensor;
augmenting the at least one digital resource with the data from the sensor to produce content that is responsive to the user need; and
presenting the content that is responsive to the user need.
